(19) United States
(12) Patent Application Publication
(10) Pub. No.: US 2008/0104680 A1
(43) Pub. Date: May 1, 2008

(54) Local Blade Server Security

(76) Inventors: Gregg K. Gibson, Apex, NC (US); Eric R. Kern, Chapel Hill, NC (US); Michael S. Rollins, Durham, NC (US); Janae V. Simons, Durham, NC (US); David R. Woodham, Raleigh, NC (US); Tong Yu, Cary, NC (US)

Correspondence Address: IBM (RPS-BLF);c/o BIGGERS & OHANIAN, LLP, P.O. BOX 1469, AUSTIN, TX, 78767-1469, US

(21) Appl. No.: 11/537,755

(22) Filed: Oct. 2, 2006

(51) Int. Cl. H04L 9/32; G06K 9/00; G06F 17/30; G06F 15/16; G06F 7/04; G06F 7/58; G06K 19/00

(52) U.S. Cl. 726/5; 726/6; 726/7; 726/9

(57) ABSTRACT

Methods, systems, and products for local blade server security are provided. Embodiments include extracting authentication information for a local user from a USB keydrive inserted in the chassis of the blade server; comparing the extracted authentication information with predetermined authentication credentials; and granting access to one or more resources on the blade server if the extracted authentication information matches the predetermined authentication credentials; and denying access to one or more resources on the blade server if the extracted authentication information does not match the predetermined authentication credentials.

### BACKGROUND OF THE INVENTION

1. Field of the Invention

The field of the invention is data processing, or, more specifically, methods, systems, and products for local blade server security.

2. Description of Related Art

Management modules of conventional blade servers require authentication of any remote user to remotely control the blade server. This authentication is required for a remote user to remotely switch to a blade, see the video on a blade, control a blade and so on. However, authentication is only required for remote users not local users. There is therefore an ongoing need for improvement in blade server security.

### SUMMARY OF THE INVENTION

Methods, systems, and products for local blade server security are provided.

Embodiments include extracting authentication information for a local user from a USB keydrive inserted in the chassis of the blade server; comparing the extracted authentication information with predetermined authentication credentials; and granting access to one or more resources on the blade server if the extracted authentication information matches the predetermined authentication credentials; and denying access to one or more resources on the blade server if the extracted authentication information does not match the predetermined authentication credentials.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for local blade server security.

FIG. 2 sets forth a block diagram illustrating an exemplary system for local blade server security according to the present invention.

FIG. 3 sets forth a flow chart illustrating an exemplary method for local blade server security.

FIG. 4 sets forth a flow chart illustrating an exemplary method for extracting authentication information for a local user from a USB keydrive inserted in the chassis of the blade server.

FIG. 5 sets forth a flow chart illustrating another exemplary method for extracting authentication information for a local user from a USB keydrive inserted in the chassis of the blade server.

FIG. 6 sets forth a flow chart illustrating an exemplary method for granting access to one or more resources on the blade server.

### DETAILED DESCRIPTION OF EXEMPLARY EMBODIMENTS

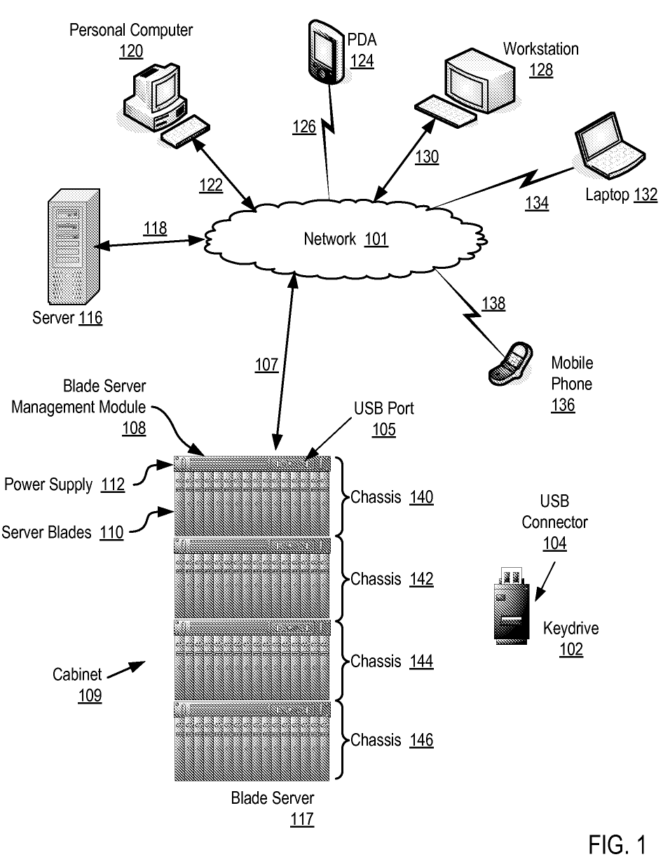

Exemplary methods, systems, and products for local blade server security according to embodiments of the present invention are described with reference to the accompanying drawings, beginning with FIG. 1. FIG. 1 sets forth a network diagram illustrating an exemplary system for local blade server security. The system of FIG. 1 operates generally to provide local blade server security by extracting authentication information for a local user from a USB keydrive inserted in the chassis of the blade server; comparing the extracted authentication information with predetermined authentication credentials; and granting access to one or more resources on the blade server if the extracted authentication information matches the predetermined authentication credentials; and denying access to one or more resources on the blade server if the extracted authentication information does not match the predetermined authentication credentials.

The system of FIG. 1 includes a blade server (117). The blade server of FIG. 1 is a housing for a number of individual, and often minimally-packaged, computer motherboard “blades”, each including one or more processors, memory, storage, and network connections, but sharing a common power supply (112) and air-cooling resources of a blade server chassis (140).

The blade server chassis (140) is installed in a cabinet (109) with several other blades server chassis (142, 144, 146). Each blade server chassis is computer hardware that houses and provides common power, cooling, network, storage, and media peripheral resources to one or more server blades. Examples of blade server chassis useful with the present invention include the IBM eServer® BladeCenter™ Chassis, the Intel® Blade Server Chassis SBCE, the Dell™ PowerEdge 1855 Enclosure, and so on.

In the system of FIG. 1, each blade server chassis includes a blade server management module (108). The blade server management module (108) is an embedded computer system for controlling resources provided by each blade server chassis (140) to one or more server blades. The resources controlled by the blade server management module (108) may include, for example, power resources, cooling resources, network resources, storage resources, media peripheral resources, and so on. An example of an embedded blade server management module (108) that may be improved for local blade server security according to the present invention includes the IBM eServer™ BladeCenter® Management Module. The blade server management module (108) of FIG. 1 is improved for local blade server security according to embodiments of the present invention. The blade server management module (108) of FIG. 1 therefore includes computer program instructions capable of extracting authentication information for a local user from a USB keydrive inserted in the chassis of the blade server; comparing the extracted authentication information with predetermined authentication credentials; and granting access to one or more resources on the blade server if the extracted authentication information matches the predetermined authentication credentials; and denying access to one or more resources on the blade server if the extracted authentication information does not match the predetermined authentication credentials.

The blade server chassis (140) of FIG. 1 also includes a USB port (105) for receiving a keydrive (102) having a USB connector (104). Universal Serial Bus (‘USB’) is an external peripheral interface standard for communication between a computer and external peripherals over a cable using bi-serial transmission. The USB keydrive of FIG. 1 is flash memory integrated with a USB interface used as a small, lightweight, removable data storage device. The USB keydrive of FIG. 1 has stored upon it authentication information useful for local blade server security according to embodiments of the present invention.

Each blade server chassis in the system of FIG. 1 includes server blades (110) that execute computer software applications. A computer software application is computer program instructions for user-level data processing implementing threads of execution. Server blades (110) are minimally-packaged computer motherboards that include one or more computer processors, computer memory, and network interface modules. The server blades (110) are hot-swappable and connect to a backplane of a blade server chassis through a hot-plug connector. Blade server maintenance personnel insert and remove server blades (110) into slots of a blade server chassis to provide scalable computer resources in a computer network environment. Server blades (110) connect to network (101) through wireline connection (107) and a network switch installed in a blade server chassis. Examples of server blades (110) that may be useful according to embodiments of the present invention include the IBM eServer® BladeCenter™ HS20, the Intel® Server Compute Blade SBX82, the Dell™ PowerEdge 1855 Blade, and so on.

The system of FIG. 1 includes a number of devices (116, 120, 124, 128, 132, 136) coupled for data communications with the blade server (107) through a network (101). Server (116) connects to network (101) through wireline connection (118). Personal computer (120) connects to network (101) through wireline connection (122). Personal Digital Assistant (‘PDA’) (124) connects to network (101) through wireless connection (126). Workstation (128) connects to network (101) through wireline connection (130). Laptop (132) connects to network (101) through wireless connection (134). Network enabled mobile phone (136) connects to network (101) through wireless connection (138).

The network connection aspect of the architecture of FIG. 1 is only for explanation, not for limitation. In fact, systems for local blade server security according to embodiments of the present invention may be connected to LANs, WANs, intranets, internets, the Internet, webs, the World Wide Web itself, or other connections as will occur to those of skill in the art. Such networks are media that may be used to provide data communications connections between various devices and computers connected together within an overall data processing system.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

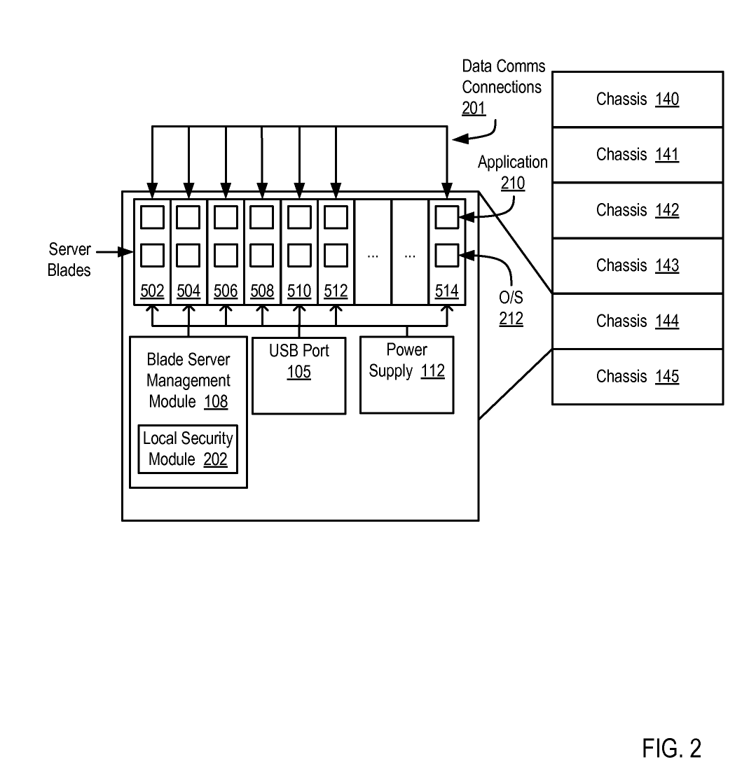

For further explanation, FIG. 2 sets forth a block diagram illustrating an exemplary system for local blade server security according to the present invention. In the example of FIG. 2, chassis (144) includes server blades (502-514). The system of FIG. 2 includes server blades (502-514) connected to the workload manager (100) through data communications connections (201) such as, for example, TCP/IP connections or USB connections. Each server blade (502-514) has installed upon it an operating system (212). Operating systems useful in blade servers implementing local blade server security according to the present invention include UNIX™, Linux™, Microsoft XP™, AIX™, IBM's i5/OS™, and so on. Each server blade (502-514) also has installed upon it a computer software application (210) assigned to the server blade (502-514).

In the system of FIG. 2, each blade server chassis (140-145) includes a power supply (112) that supplies power to each of the server blades (502-514) in the blade server chassis. The power supply (112) is computer hardware that conforms power provided by a power source to the power requirements of a server blade (502-514).

Although FIG. 2 depicts a single power supply (112) in each blade server chassis (140-145), such a depiction is for explanation and not for limitation. In fact, more than one power supply (112) may be installed in each blade server chassis (140-145) or a single power supply (112) may supply power to server blades (502-514) contained in multiple blade server chassis (140-145).

In the system of FIG. 1, the blade server chassis (144) includes a blade server management module (108). The blade server management module (108) is an embedded computer system for controlling resources provided by each blade server chassis (140) to one or more server blades. The blade server management module (108) of FIG. 1 includes a local security module (202) capable of local blade server security according to embodiments of the present invention. The blade server management module (108) of FIG. 1 therefore includes computer program instructions capable of extracting authentication information for a local user from a USB keydrive inserted in the USB port (105) of the chassis of the blade server; comparing the extracted authentication information with predetermined authentication credentials; and granting access to one or more resources on the blade server if the extracted authentication information matches the predetermined authentication credentials; and denying access to one or more resources on the blade server if the extracted authentication information does not match the predetermined authentication credentials.

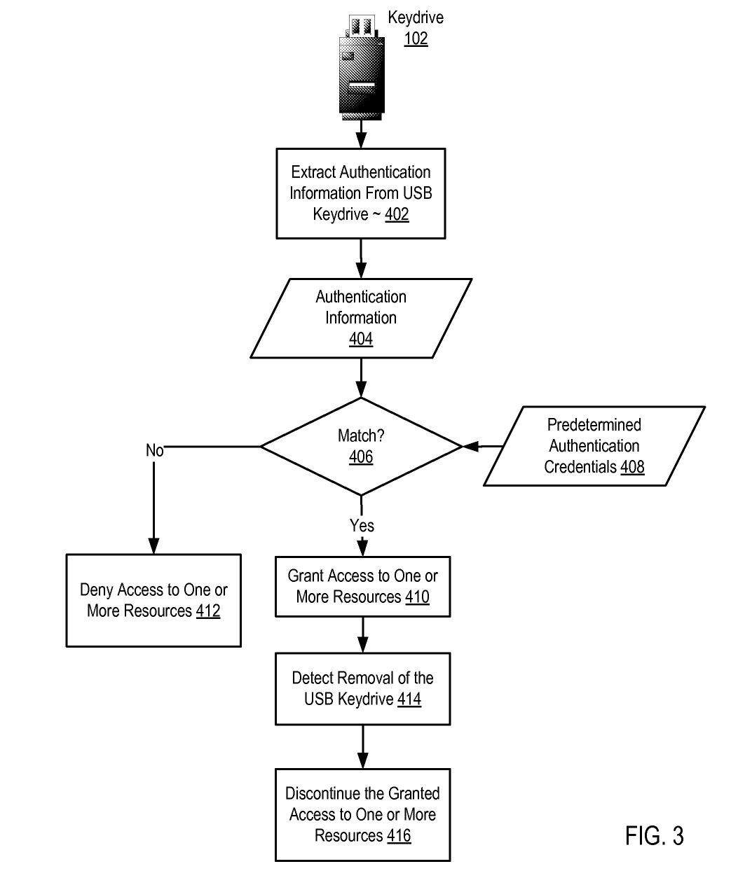

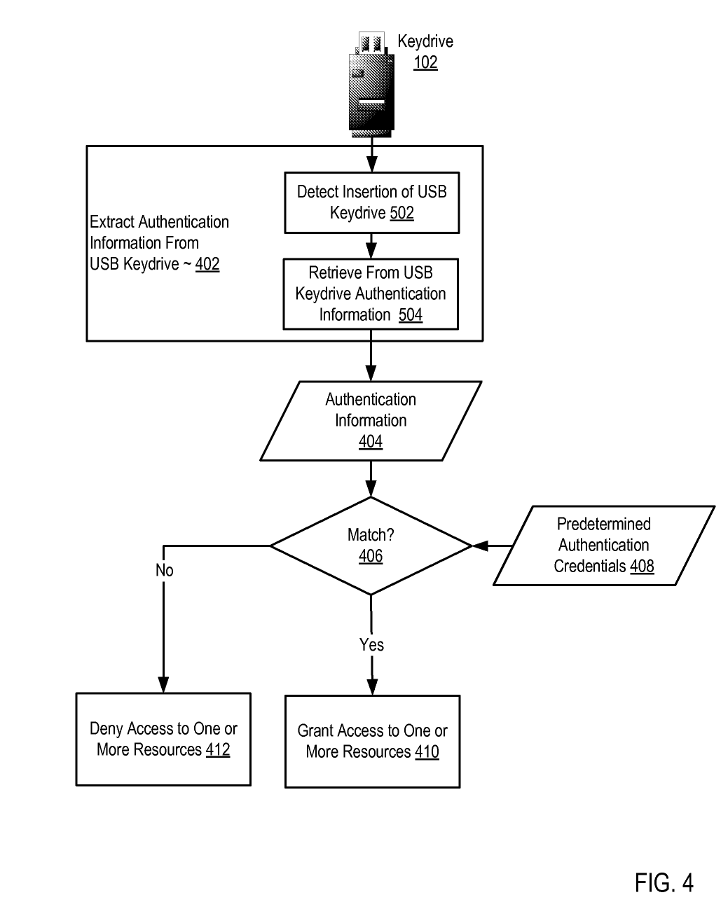

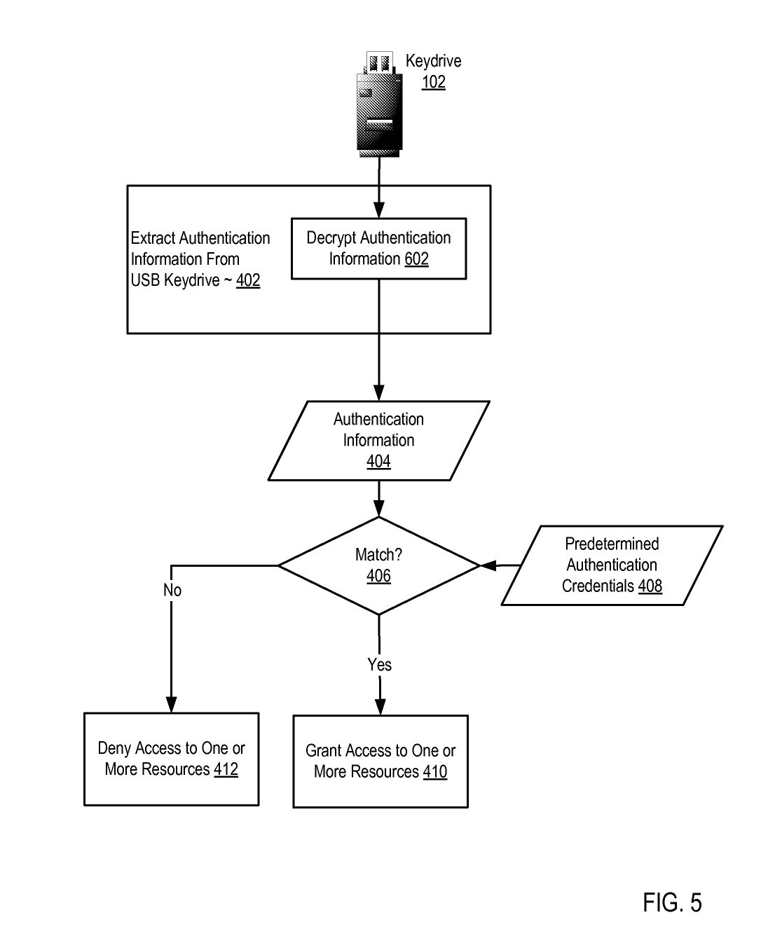

For further explanation, FIG. 3 sets forth a flow chart illustrating an exemplary method for local blade server security. The method of FIG. 3 includes extracting (402) authentication information (404) for a local user from a USB keydrive inserted in the chassis of the blade server. Extracting (402) authentication information (404) for a local user from a USB keydrive inserted in the chassis of the blade server may be carried out by detecting the insertion of the USB keydrive (102) into the chasis of a blade server and retrieving from the USB keydrive authentication information as discussed below with reference to FIG. 4. Extracting authentication information for a local user from a USB keydrive inserted in the chassis of the blade server may also include decrypting (602) encrypted authentication information (404) retrieved from the USB keydrive (102) as discussed below with reference to FIG. 5.

The method of FIG. 3 also includes comparing (406) the extracted authentication information (404) with predetermined authentication credentials (408). Predetermined authentication credentials (408) are authentication credentials assigned to users authorized to access one or more resources of the blade server. Such predetermined authentication credentials may be user names for authorized users and their associated passwords. Such predetermined authentication credentials may be stored locally on the blade server or stored remotely and accessible through a network.

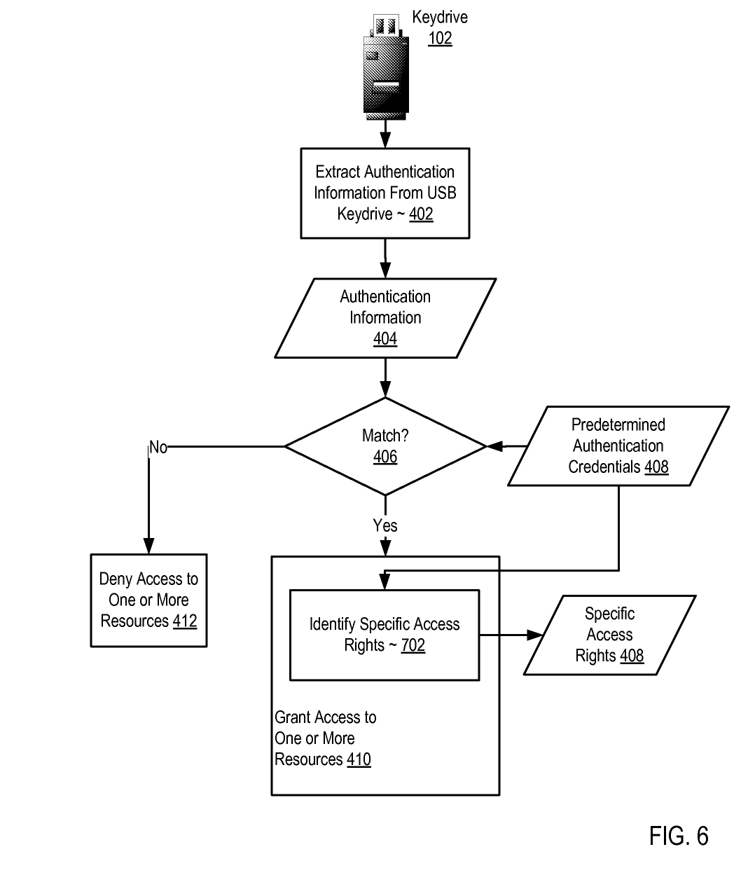

The method of FIG. 3 includes granting (410) access to one or more resources on the blade server if the extracted authentication information (404) matches the predetermined authentication credentials (408) and denying (412) access to one or more resources on the blade server if the extracted authentication information does not match the predetermined authentication credentials (408). Granting (410) access to one or more resources on the blade server may be carried out by identifying specific access rights for the local user in dependence upon the predetermined authentication credentials as discussed below with reference to FIG. 6.

The method of FIG. 3 also includes detecting (414) the removal of the USB keydrive (102) and discontinuing (416) the granted access to the one or more resources. Detecting (414) the removal of the USB keydrive (102) may be carried out by a USB virtualization engine of a blade server management module. Discontinuing (416) the granted access to the one or more resources locks out unauthorized users until a USB keydrive is inserted in the chassis of the blade server that includes authentication information that matches predetermined authentication credentials. The method of FIG. 3 therefore typically continues by continuing to deny access to the one or more resources on the blade server until a USB keydrive is inserted in the chassis of the blade server that includes authentication information that matches predetermined authentication credentials.

In some embodiments, rather than detecting the removal of the USB keydrive or in addition to detecting the removal of the USB keydrive access to the resources may time out. That is, the method of FIG. 3 may also include timing out access to the one or more resources at a predetermined time if access to one or more resources on the blade server is granted. The predetermined time may be designed to be long enough to provide enough time for authorized and authenticated users to access the resources and still be short enough to reduce the possibility of an authorized user leaving the local blade server unsecured. Timing out access to the resources advantageously provides additional local security features to the blade server.

As discussed above, local blade server security according to the present invention includes extracting authentication information for a local user. For further explanation, therefore, FIG. 4 sets forth a flow chart illustrating an exemplary method for extracting authentication information for a local user from a USB keydrive inserted in the chassis of the blade server. The method of FIG. 4 also includes detecting (502) the insertion of the USB keydrive (102) into the chasis. Detecting (502) the insertion of the USB keydrive (102) into the chasis may be carried out by a USB virtualization engine of a blade server management module implementing local blade server security according to the present invention.

The method of FIG. 4 also includes retrieving (504) from the USB keydrive (102) authentication information (404). Retrieving (504) from the USB keydrive (102) authentication information (404) may be carried out by searching the flash memory of the USB keydrive for the authentication information identified using a predefined format. For example, the authentication information may be stored using a predefined file name.

As mentioned above, authentication information extracted from the USB keydrive may be encrypted using, for example, public key-private key encryption. For further explanation, therefore, FIG. 5 sets forth a flow chart illustrating another exemplary method for extracting authentication information for a local user from a USB keydrive inserted in the chassis of the blade server. The method of FIG. 5 also includes decrypting (602) encrypted authentication information (404) retrieved from the USB keydrive (102). Encrypting the authentication information provides additional local security for the blade server.

For further explanation, FIG. 6 sets forth a flow chart illustrating an exemplary method for granting access to one or more resources on the blade server. The method of FIG. 6 includes identifying specific access rights for the local user in dependence upon the predetermined authentication credentials. Identifying specific access rights for the local user may be carried out by searching a database for specific access rights assigned to the authenticated local user. Such access rights may define access to particular resources, particular actions allowed with the resources and so on as will occur to those of skill in the art.

Exemplary embodiments of the present invention are described largely in the context of a fully functional computer system for local blade server security. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for local blade server security, the method comprising:
extracting authentication information for a local user from a USB keydrive inserted in the chassis of the blade server;
comparing the extracted authentication information with predetermined authentication credentials; and
granting access to one or more resources on the blade server if the extracted authentication information matches the predetermined authentication credentials; and
denying access to one or more resources on the blade server if the extracted authentication information does not match the predetermined authentication credentials.

2. The method of claim 1 wherein extracting authentication information for a local user from a USB keydrive inserted in the chassis of the blade server further comprises:
detecting the insertion of the USB keydrive into the chasis; and
retrieving from the USB keydrive authentication information.

3. The method of claim 1 wherein extracting authentication information for a local user from a USB keydrive inserted in the chassis of the blade server further comprises decrypting the authentication information retrieved from the USB keydrive.

4. The method of claim 1 wherein granting access to one or more resources on the blade server further comprises identifying specific access rights for the local user in dependence upon the predetermined authentication credentials.

5. The method of claim 1 further comprising:
detecting the removal of the USB keydrive; and
discontinuing the granted access to the one or more resources.

6. The method of claim 1 further comprising denying access to one or more resources on the blade server until a USB keydrive is inserted in the chassis of the blade server that includes authentication information that matches predetermined authentication credentials.

7. The method of claim 1 further comprising timing out access to the one or more resources at a predetermined time if access to one or more resources on the blade server is granted.

8. A system for local blade server security, the system comprising:
a computer processor;
a computer memory operatively coupled to the computer processor, the computer memory having disposed within it computer program instructions capable of:
extracting authentication information for a local user from a USB keydrive inserted in the chassis of the blade server;
comparing the extracted authentication information with predetermined authentication credentials; and
granting access to one or more resources on the blade server if the extracted authentication information matches the predetermined authentication credentials; and
denying access to one or more resources on the blade server if the extracted authentication information does not match the predetermined authentication credentials.

9. The system of claim 8 wherein computer program instructions capable of extracting authentication information for a local user from a USB keydrive inserted in the chassis of the blade server further comprise computer program instructions capable of:
detecting the insertion of the USB keydrive into the chasis; and
retrieving from the USB keydrive authentication information.

10. The system of claim 8 wherein computer program instructions capable of extracting authentication information for a local user from a USB keydrive inserted in the chassis of the blade server further comprise computer program instructions capable of decrypting the authentication information retrieved from the USB keydrive.

11. The system of claim 8 wherein computer program instructions capable of granting access to one or more resources on the blade server further comprise computer program instructions capable of identifying specific access rights for the local user in dependence upon the predetermined authentication credentials.

12. The system of claim 8 wherein the computer memory also has disposed within it computer program instructions capable of:
detecting the removal of the USB keydrive; and
discontinuing the granted access to the one or more resources.

13. The system of claim 8 wherein the computer memory also has disposed within it computer program instructions capable of denying access to one or more resources on the blade server until a USB keydrive is inserted in the chassis of the blade server that includes authentication information that matches predetermined authentication credentials.

14. The system of claim 8 wherein the computer memory also has disposed within it computer program instructions capable of timing out access to the one or more resources at a predetermined time if access to one or more resources on the blade server is granted.

15. A computer program product for local blade server security, the computer program product, the computer program product embodied on a computer-readable medium, the computer program product comprising:
computer program instructions for extracting authentication information for a local user from a USB keydrive inserted in the chassis of the blade server;
computer program instructions for comparing the extracted authentication information with predetermined authentication credentials; and
computer program instructions for granting access to one or more resources on the blade server if the extracted authentication information matches the predetermined authentication credentials; and
computer program instructions for denying access to one or more resources on the blade server if the extracted authentication information does not match the predetermined authentication credentials.

16. The computer program product of claim 15 wherein computer program instructions for extracting authentication information for a local user from a USB keydrive inserted in the chassis of the blade server further comprise:
computer program instructions for detecting the insertion of the USB keydrive into the chasis; and
computer program instructions for retrieving from the USB keydrive authentication information.

17. The computer program product of claim 15 wherein computer program instructions for extracting authentication information for a local user from a USB keydrive inserted in the chassis of the blade server further comprise computer program instructions for decrypting the authentication information retrieved from the USB keydrive.

18. The computer program product of claim 15 wherein computer program instructions for granting access to one or more resources on the blade server further comprise computer program instructions for identifying specific access rights for the local user in dependence upon the predetermined authentication credentials.

19. The computer program product of claim 15 further comprising:
computer program instructions for detecting the removal of the USB keydrive; and
computer program instructions for discontinuing the granted access to the one or more resources.

20. The computer program product of claim 15 further comprising computer program instructions for timing out access to the one or more resources at a predetermined time if access to one or more resources on the blade server is grated.
